(19) United States
(12) Patent Application Publication
(10) Pub. No.: US 2017/0183510 A1
(43) Pub. Date: Jun. 29, 2017

(54) CONDUCTIVE ROLLER COATING COMPOSITION, AND DEVELOPING ROLLER AND IMAGE FORMATION DEVICE USING SAME

(71) Applicant: BRIDGESTONE CORPORATION, Tokyo (JP)

(72) Inventors: Yusuke FUJISAWA, Yokohama-shi (JP); Shogo IMAI, Ashikaga-shi (JP)

(73) Assignee: BRIDGESTONE CORPORATION, Tokyo (JP)

(21) Appl. No.: 15/300,586

(22) PCT Filed: Jun. 21, 2013
(86) PCT No.: PCT/JP2013/067133

§ 371 Date: Mar. 13, 2017

(30) Foreign Application Priority Data
Jun. 27, 2012 (JP) 2012-144773

(51) Int. Cl. C09D 5/24; C09D 7/12; C08G 18/76; G03G 15/08; C08G 18/24; C08G 18/48; C08J 9/00; C09D 175/04; C08G 18/10

(52) U.S. Cl. CPC C09D 5/24; C09D 175/04; C09D 7/1283; C08G 18/7621; C08G 18/10; C08G 18/246; C08G 18/48; C08J 9/00; G03G 15/0808; C08J 2475/08

(57) ABSTRACT

Provided is a conductive roller coating composition which can reduce degradation of toner during durable printing when used for a developing roller, and a developing roller and image formation device using the same. In a conductive roller coating composition containing a resin component including a polyol and an isocyanate, and microparticles, a Tg of the microparticles is −13° C. or less. In a developing roller including: a shaft 1; and an elastic layer 2 supported on an outer periphery of the shaft 1, an outer periphery of the elastic layer 2 is coated with the conductive roller coating composition.

### TECHNICAL FIELD

The present invention relates to a conductive roller coating composition, and a developing roller (hereinafter, also simply referred to as “coating composition” and “roller”) and image formation device using the same, and particularly to improvement of a conductive roller coating composition containing microparticles, and a developing roller and image formation device using the same.

### BACKGROUND ART

In general, as a developing method in an electrophotographic image formation device such as a copying machine or a printer, a pressure developing method which supplies toner to an image forming body such as a photosensitive drum holding an electrostatic latent image and visualizes the latent image by attaching toner to the latent image on the image forming body is used. In this pressure developing method, for example, after an image forming body is charged to a fixed potential, an electrostatic latent image is formed on the image forming body by an exposure device, and then, a developing roller supporting toner is brought into contact with the image forming body holding the electrostatic latent image, and the toner is allowed to be adhered to the latent image of the photosensitive drum, thereby performing development.

In the above process of image formation, the developing roller has to rotate while surely keeping a state of being in close contact with the image forming body. For this reason, in general, a developing roller has a structure in which a semi-conductive elastic body in which carbon black or metal powder is dispersed in an elastomer such as polyurethane or silicone rubber or a semi-conductive elastic layer made of a foam obtained by foaming these is supported on the outer periphery of a shaft made of a highly conductive material such as metal. A surface layer may be further formed on the surface of the elastic layer for the purpose of controlling the charging property and the adhesion to toner, prevention of contamination of the image forming body by the elastic layer, or the like.

As a conventional technique relating to a developing roller, for example, Patent Document 1 discloses a developing roll for an electrophotographic apparatus, the roll surface layer comprising dotted protruding portions and a recessed portion formed between the protruding portions and containing a toner particle, wherein in the surface layer, under the concave portion and the convex portion, particles are present, and the surface hardness of the concave portion is lower than the surface hardness of the convex portion. Patent Document 2 discloses a developing roll, comprising: a shaft body; a base layer formed on the outer periphery surface of the shaft body; and a surface layer formed on the outer periphery of the base layer, wherein the base layer is formed using silicone rubber, and the surface layer is formed by using (A) urethane raw material, (B) a conductive agent, and (C) an electrically conductive composition containing mixed microparticles including large particle diameter particles having an average particle diameter of 10 to 14 μm and small particle diameter particles having an average particle diameter of 3 to 5 μm at a predetermined mixing weight ratio.

Further, Patent Document 3 discloses a developing roller, comprising: a shaft; an elastic layer formed on the outer periphery; and a surface coating layer formed on the outer periphery surface, wherein the elastic layer is made of a foam, and the surface coating layer contains a urethane resin obtained by crosslinking a lactone-modified polyol with two or more kinds of polyisocyanates containing at least isophorone diisocyanate.

### RELATED ART DOCUMENTS

### Patent Documents

Patent Document 1: Japanese Unexamined Patent Application Publication No. 2009-237042 (claims and the like)

Patent Document 2: Japanese Unexamined Patent Application Publication No. 2005-258201 (claims and the like)

Patent Document 3: Japanese Unexamined Patent Application Publication No. 2007-298662 (claims and the like)

### SUMMARY OF THE INVENTION

### Problems to be Solved by the Invention

In recent years, along with demands for higher durability of electrophotographic apparatuses, even higher durability is demanded even for developing rollers. However, particularly, in the case of performing endurance printing under a severe environment, fusing of toner may occur as the toner deteriorates due to friction between a developing roller and a developing blade in contact therewith. When such fusion of toner occurs in the blade, development streaks occur, and when such fusion of toner occurs in the developing roller, filming occurs. Both cases cause an image defect. A developing roller capable of minimizing degradation of toner has, therefore, been needed.

Accordingly, an object of the present invention is to resolve the above-described problem, and to provide a conductive roller coating composition which can reduce degradation of toner during durable printing when used for a developing roller, and a developing roller and image formation device using the same.

### Means for Solving the Problems

The present inventor intensively studied to find that the above problem can be solved by using, as microparticles contained in the surface layer forming the outermost surface of a developing roller, microparticles satisfying a predetermined glass transition temperature (Tg), thereby completing the present invention.

That is, the conductive roller coating composition according to the present invention is a conductive roller coating composition containing a resin component including a polyol and an isocyanate, and microparticles,

wherein a Tg of the microparticles is −13° C. or less.

In the coating composition according to the present invention, preferably, a Tg of the resin component is 0° C. or less. In the coating composition according to the present invention, preferably, the microparticles are made of a polyurethane resin. Further, in the coating composition according to the present invention, suitably, an average particle diameter of the microparticles is 10 μm or more. Still further, in the coating composition according to the present invention, preferably, from 1.5 to 6.0 parts by mass of the microparticles are contained with respect to 100 parts by mass of the polyol component. Still further, in the coating composition according to the present invention, preferably, a universal hardness of the microparticles at an indentation depth of 1 μm is 2.0 or less.

The developing roller according to the present invention is a developing roller comprising: a shaft; and an elastic layer supported on an outer periphery of the shaft,

wherein an outer periphery of the elastic layer is coated with the conductive roller coating composition according to the present invention.

Further, the image formation device according to the present invention is an image formation device,

wherein the developing roller according to the present invention is mounted.

### Effects of the Invention

According to the present invention, by employing the above configuration, it becomes possible to realize a conductive roller coating composition which can reduce degradation of toner during durable printing when used for a developing roller, and a developing roller and image formation device using the same.

### BRIEF DESCRIPTION OF THE DRAWINGS

FIG. 1 is a longitudinal cross-sectional view illustrating one example of a developing roller of the present invention.

FIG. 2 is a drawing for explaining one example of an image formation device according to the present invention.

### MODE FOR CARRYING OUT THE INVENTION

Hereinafter, embodiments of the present invention will be described in detail with reference to the drawings.

First, the conductive roller coating composition of the present invention contains a resin component including a polyol and an isocyanate, and microparticles, and is used for forming a surface layer of a conductive roller.

In the coating composition according to the present invention, it is important that the Tg of the above microparticles is −10° C. or lower, suitably −13° C. or lower, and more suitably −30° C. or lower. By containing microparticles having a low Tg, that is, having a low hardness in a coating composition, when a surface layer of a conductive roller is formed using the coating composition, friction between the roller and another member such as a blade can be reduced. In other words, as the microparticles are flexible, when the toner rubs against the blade, a convex portion in the unevenness of the roller surface becomes flexible, and therefore, degradation of the toner is considered to be reduced. Therefore, according to the present invention, degradation of the toner during durable printing can be reduced, thereby suppressing occurrence of an image defect due to fusion of toner to the roller or the blade.

In the present invention, as such microparticles, it is preferable to use those having a low hardness with a universal hardness at an indentation depth of 1 μm of 2.0 or less, for example, from 0.6 to 1.8. When the hardness of the microparticles is increased, the load on the toner is increased, the toner is crushed between the blade and the microparticles, and it is considered that toner fusion to the blade is likely to occur, which is a cause of development streaks. The hardness of the microparticles is substantially proportional to the value of the Tg, and is smaller as the Tg is lower, and specifically, the hardness is preferably in the above range. In the present invention, the universal hardness of the microparticles can be obtained by measuring a microparticle portion in the surface layer when the surface layer of the roller is formed, by using a Fischer hardness meter.

The material of such microparticles is not particularly restricted as long as the value of the above Tg is satisfied, and for example, a polyurethane resin having a lower hardness than a melamine resin, an acrylic resin, or the like can be suitably used.

Also, in the present invention, the particle diameter of such microparticles is also important, and preferably, microparticles having an average particle diameter of 10 μm or more are used. By increasing the particle diameter of the microparticles to some extent, a gap can be secured between the layer formed by using the coating composition and the blade. As the result, the toner carrying performance can be improved and the effect of reducing toner degradation can be obtained. On the other hand, if the particle diameter of the microparticles is too large, image unevenness occurs, and therefore, more preferably, microparticles having an average particle diameter of from 10 to 16 μm, and still more preferably from 12 to 14 μm are used. When microparticles having a particle diameter of more than 16 μm are used, image unevenness may occur, which is not preferable for the developing roller.

The content of such microparticles is preferably from 1.5 to 6.0 parts by mass, and more preferably from 2.0 to 4.5 parts by mass, with respect to 100 parts by mass of the polyol component. When the blending ratio of the microparticles is small, the gap between a layer formed by using a coating composition and the blade becomes insufficient. When the blending ratio of the microparticles is large, the influence of friction between the microparticles and toner becomes large. When the blending ratio of the microparticles is within the above range, the effect of reducing toner degradation can be reliably obtained while securing the toner carrying performance.

A resin component which is a main component of the coating composition is not particularly restricted as long as the resin component is a resin component containing polyol and isocyanate, and suitably, a resin component having a Tg of 0° C. or less and particularly −10° C. or less is used. By using a coating composition in which flexible particles are combined with a flexible resin component, it is possible to obtain a high-quality developing roller in which friction between a layer to be formed and toner is further reduced, thereby reducing toner degradation. It is known that as a resin component constituting a layer is more flexible, toner degradation is more effectively reduced. However, when the hardness of microparticles contained in the layer is high, the usefulness of the the resin component is not utilized. In the present invention, by using flexible microparticles and further combining a flexible resin component therewith, a larger effect of reducing toner degradation can be obtained. When the Tg is lower than −20° C., the hardness of the surface is significantly decreased, and blade set marks are generated in a high temperature and high humidity shelf test in a state of being assembled in a cartridge, which is not preferable.

Specifically, as such a resin component, for example, a urethane resin obtained by crosslinking a lactone-modified polyol with two or more kinds of polyisocyanates containing at least isophorone diisocyanate can be suitably used. The lactone-modified polyol can be produced by modifying a terminal end of a polyol with a lactone such as ε-caprolactone, and a commercially available product can also be utilized. From the viewpoint of achieving both compression set performance and resistance against toner fusion when applied to a conductive roller, the lactone-modified polyol preferably has a number average molecular weight (Mn) in terms of polystyrene measured by gel permeation chromatography of from 1,000 to 5,000, and more preferably from 1,000 to 3,000. The molecular weight distribution (Mw/Mn) represented by the ratio between the weight average molecular weight (Mw) and number average molecular weight (Mn) in terms of polystyrene measured by gel permeation chromatography is preferably 2.5 or less, and more preferably 2.0 or less.

Examples of the polyol modified with a lactone include a polyether polyol obtained by addition polymerization of an alkylene oxide such as ethylene oxide or propylene oxide to glycerin and the like, polytetramethylene glycol, glycerin, ethylene glycol, propylene glycol, butanediol, pentanediol, hexanediol, octanediol, polybutadiene polyol, polyisoprene polyol, and polyester polyol.

A polyisocyanate which crosslinks a lactone-modified polyol is two or more kinds of polyisocyanates containing at least isophorone diisocyanate. By using isophorone diisocyanate, it is possible to improve the resistance against toner fusion at the time of use for a long period of time when a coating composition is applied to a developing roller. Examples of polyisocyanates other than isophorone diisocyanate (IPDI) among the above two or more kinds of polyisocyanates include tolylene diisocyanate (TDI), diphenylmethane diisocyanate (MDI), crude diphenylmethane diisocyanate (crude MDI), hydrogenated diphenylmethane diisocyanate, hydrogenated tolylene diisocyanate, hexamethylene diisocyanate (HDI), and isocyanurate-modified hexamethylene diisocyanate. From the viewpoint of achieving both low hardness and compression set performance of a layer formed by the coating composition, the two or more kinds of polyisocyanates used for crosslinking the lactone-modified polyol are preferably isophorone diisocyanate and hexamethylene diisocyanate, and the molar ratio between isophorone diisocyanate and hexamethylene diisocyanate is more preferably 3:1 to 1:3.

In the coating composition, a catalyst for accelerating the crosslinking reaction between a lactone-modified polyol and two or more kinds of polyisocyanates can be further contained. Examples of such catalysts include organic tin compounds such as dibutyl tin dilaurate, dibutyl tin diacetate, dibutyl tin thiocarboxylate, dibutyl tin dimaleate, dioctyl tin thiocarboxylate, and tinoctenate; organic lead compounds such as lead octenate; monoamines such as triethyl amine, and dimethyl cyclohexyl amine; diamines such as tetramethylethylenediamine, tetramethylpropanediamine, and tetramethylhexanediamine; triamines such as pentamethyldiethylenetriamine, pentamethyldipropylenetriamine and tetramethylguanidine; cyclic amines such as triethylenediamine, dimethylpiperazine, methyl ethyl piperazine, methyl morpholine, dimethyl aminoethyl morpholine, and dimethyl imidazole; alcohol amines such as dimethylaminoethanol, dimethylaminoethoxyethanol, trimethylaminoethylethanolamine, methylhydroxyethylpiperazine, and hydroxyethylmorpholine; and ether amines such as bis(dimethylaminoethyl)ether and ethylene glycol bis(dimethyl)aminopropyl ether. Among these catalysts, organotin compounds are preferred. One kind of these catalysts may be used singly, or two or more kinds of these catalysts may be used in combination. The amount of the catalyst to be used is preferably from 0.001 to 2.0 parts by mass, with respect to 100 parts by mass of the polyol.

The electrical conductivity of a coating composition can be adjusted by adding a conductive agent such as an electroconductive agent or an ion conductive agent to the coating composition. Examples of the electroconductive agent include conductive carbon such as Ketjen black, and acetylene black; carbon black for rubber such as SAF, ISAF, HAF, FEF, GPF, SRF, FT, and MT; carbon black for color subjected to oxidation or the like; pyrolytic carbon black; natural graphite; artificial graphite; metal oxides such as antimony doped tin oxide, ITO, tin oxide, titanium oxide, and zinc oxide; metals such as nickel, copper, silver, and germanium; conductive polymers such as polyaniline, polypyrrole, and polyacetylene; and conductive whiskers such as carbon whiskers, graphite whiskers, titanium carbide whiskers, conductive potassium titanate whiskers, conductive barium titanate whiskers, conductive titanium oxide whiskers, and conductive zinc oxide whiskers.

Examples of the ion conductive agent include: ammonium salts such as perchlorates, chlorates, hydrochlorides, bromates, iodates, fluoroborates, sulfates, ethylsulfates, carboxylates, sulfonates, and the like of tetraethylammonium, tetrabutylammonium, dodecyltrimethylammonium, hexadecyltrimethylammonium, benzyltrimethylammonium, modified fatty acid dimethylethylammonium and the like and the like; and perchlorates, chlorates, hydrochlorides, bromates, iodates, fluoroborates, sulfates, trifluoromethyl sulfates, sulfonates, and the like of alkali metals and alkaline earth metals such as lithium, sodium, potassium, calcium, magnesium, and the like. The above-described conductive agents may be used singly or in combination of two or more kinds thereof, and an electroconductive agent and an ion conductive agent may be used in combination.

The blending ratio of the ion conductive agent in the coating composition is preferably 20 parts by mass or less, more preferably from 0.01 to 20 parts by mass, and further preferably from 1 to 10 parts by mass, with respect to 100 parts by mass of the resin component. On the other hand, the blending ratio of the electroconductive agent in the coating composition is preferably from 1 to 70 parts by mass, and more preferably from 5 to 50 parts by mass, with respect to 100 parts by mass of the resin component. The volume resistance value of a layer formed using the coating composition is preferably adjusted to from 10³ to 10¹⁰ Ω·cm and more preferably from 10⁴ to 10⁸ Ω·cm by adding the above-described conductive agent.

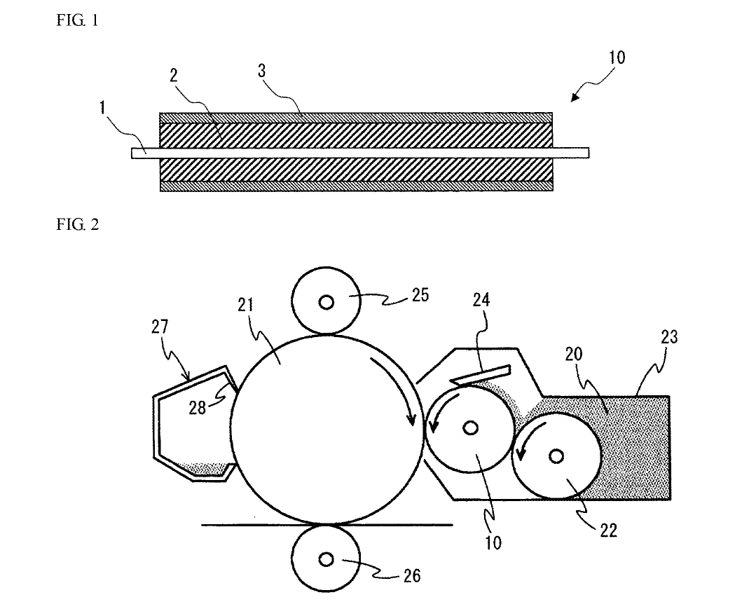

Next, the developing roller of the present invention includes a shaft and an elastic layer supported on the outer periphery thereof, and the outer periphery of the elastic layer is coated with the conductive roller coating composition of the present invention. FIG. 1 is a longitudinal cross-sectional view of one example of the developing roller of the present invention.

The illustrated developing roller 10 comprises: a shaft 1; an elastic layer 2 supported on the outer periphery of the shaft 1; and a surface layer 3 coated on the outer periphery thereof. In the developing roller 10 of the present invention, the surface layer 3 is formed of the above coating composition, which makes it possible to reduce friction between the roller and another member such as a blade, to reduce degradation of toner during durable printing, and to suppress occurrence of development streaks and roller filming. Although the surface layer 3 is a single layer in the illustrated example, the surface layer may be composed of two or more layers. In the developing roller of the present invention, since the surface layer 3 is disposed on the outer periphery of the elastic layer 2, contamination of the photosensitive drum with contaminants exuded from the elastic layer 2 can be sufficiently suppressed.

The shaft 1 is not particularly restricted as long as the shaft has a favorable conductivity. A metal core made of a metal solid body such as iron, stainless steel, or aluminum; a metal shaft such as a hollow metal cylindrical body hollowed out inside; a good conductive plastic shaft; or the like can be used.

The elastic layer 2 can be formed from a foam, and specifically, for example, the elastic layer can be formed from elastomers such as polyurethane, silicone rubber, ethylene-propylene-diene rubber (EPDM), acrylonitrile-butadiene rubber (NBR), natural rubber, styrene-butadiene rubber (SBR), butadiene rubber, isoprene rubber, polynorbomene rubber, butyl rubber, chloroprene rubber, acrylic rubber, epichlorohydrin rubber (ECO), ethylene-vinyl acetate copolymer (EVA), and mixtures thereof. Among these elastomers, polyurethane is preferably used since it is made of urethane which is a resin component constituting the surface layer 3 and therefore has better adhesion to the surface layer 3. The foam constituting the elastic layer 2 can be formed by chemically foaming the elastomer using a foaming agent, mechanically rolling air, like polyurethane foam, to foam the elastomer, or the like. Here, the expansion ratio of the foam constituting the elastic layer 2 is preferably from 1.5 to 50 times, and the density is preferably from 0.05 to 0.9 g/cm³.

When bubbles of a foam constituting the elastic layer 2 are closed cells, the compression set performance of the elastic layer is improved, and therefore, the bubbles in the foam are suitably closed cells. Here, in order to make the bubbles of the foam into closed cells, a method of foaming the raw material of the above elastomer by mechanical stirring to form a foam is suitably adopted.

By adding a conductive agent to the elastic layer 2, the conductivity of the elastic layer can be adjusted. Examples of the conductive agent used for the elastic layer 2 include electroconductive agents and ion conductive agents similar to those used in the above-described coating composition. Among them, the blending ratio of the electroconductive agent is preferably from 1 to 50 parts by mass, more preferably from 5 to 40 parts by mass, with respect to 100 parts by mass of the resin component constituting the elastic layer. The blending ratio of the ion conductive agent is preferably from 0.01 to 10 parts by mass, and more preferably from 0.05 to 5 parts by mass, with respect to 100 parts by mass of the resin component constituting the elastic layer. By adding a conductive agent, the resistance value of the elastic layer 2 is preferably set to from 10³ to 10¹⁰Ω cm, and more preferably from 10⁴ to 10⁸Ω cm. When the resistance value of the elastic layer 2 is less than 10³Ω cm, charge may leak to the photosensitive drum or the like, or the developing roller itself may be broken due to the voltage, and when the resistance value exceeds 10¹⁰Ω cm, fogging is likely to occur.

In order to make the elastomer into a rubbery substance, a crosslinking agent such as an organic peroxide or a vulcanizing agent such as sulfur may be contained in the elastic layer 2 as needed. A vulcanization aid, a vulcanization accelerator, a vulcanization acceleration aid, a vulcanization retardant, and the like may also be contained in the elastic layer. Further, in the elastic layer 2, a variety of compounding agents for rubbers such as a filler, a peptizing agent, a foaming agent, a plasticizer, a softening agent, a tackifier, an antiblocking agent, a separating agent, a releasing agent, a bulking agent or a coolant may be contained.

As described above, the surface layer 3 is formed using the coating composition of the present invention. The total thickness of the surface layer 3 is not particularly restricted, and is preferably 30 μm or less, and more preferably from 1 to 15 μm. When the total thickness of the surface layer 3 exceeds 30 μm, in some cases, the surface layer 3 becomes hard, the flexibility is deteriorated, the durability is deteriorated, cracks are generated by use, and toner is damaged, and is stuck to a photosensitive drum or a layer forming blade, which may cause image defects.

The method for forming the surface layer 3 is not particularly limited, and a method in which a coating composition containing components constituting the surface layer 3 is prepared, the coating composition is applied by a known coating method such as a dipping method, a spray method, or a roll coating method, and then cured by heating at from 100 to 120° C. for 20 to 40 minutes is preferably used.

In the illustrated developing roller 10, the surface layer 3 is disposed on the elastic layer 2, but in the present invention, an intermediate layer may be formed between the elastic layer 2 and the surface layer 3 (not illustrated). In this case, for example, by disposing an intermediate layer formed softer than the surface layer, damage to the toner can be greatly improved.

The intermediate layer can be suitably formed using any one or two or more kinds of water-based resins selected from a rubber type, a urethane type and an acrylic type. As the rubber type, latexes such as natural rubber (NR), chloroprene rubber (CR), nitrile rubber (NBR), and styrene butadiene rubber (SBR) can be suitably used; as the urethane type, emulsions and dispersions such as ether type and ester type can be suitably used; and as the acrylic type, emulsions such as acrylic and acrylic styrene can be suitably used.

The surface roughness of the developing roller of the present invention is preferably such that the JIS 10 point average roughness (Rz) is 10 μm or less. When the JIS 10 point average roughness (Rz) of the developing roller exceeds 10 μm, although the toner carrying amount tends to increase, the charge amount of the toner tends to be insufficient, causing fogging and gradation defects in the image.

The resistance value of the developing roller of the present invention is not particularly restricted, and in order to obtain a good image, the electric resistance is preferably from 10³ to 10¹⁰Ω and more preferably from 10⁴ to 10⁸Ω. When the resistance value of the developing roller is less than 10³Ω, gradation control becomes extremely difficult, and if there is a defect in the photosensitive drum, bias leakage may occur. On the other hand, when the resistance value exceeds 10¹⁰Ω, for example, in the case of developing toner on a photosensitive drum, the developing bias causes a voltage drop due to the high resistance of the developing roller itself and a developing bias sufficient for development can not be secured and a sufficient image density can not be obtained. The resistance value can be measured, for example, from the current value of an electrode when a voltage of 100 V is applied between a shaft and a counter electrode by pressing the outer periphery surface of the developing roller against a flat plate or a cylindrical counter electrode at a predetermined pressure. In this way, by appropriately and uniformly controlling the resistance value of the developing roller, it is possible to maintain the electric field strength for toner movement appropriately and uniformly.

The developing roller of the present invention preferably has an Asker C hardness of 60° or less. By using a low hardness developing roller having an Asker C hardness of 60° or less, toner is prevented from being damaged between the developing roller and the photosensitive drum, the blade, the toner supply roller and the like when incorporated in the image formation device, thereby forming a sufficiently favorable image.

Next, the image formation device of the present invention is characterized in that the developing roller of the present invention is mounted. FIG. 2 illustrates a partial cross-sectional view of one example of the image formation device of the present invention. The illustrated image formation device of the present invention comprises an image forming body 21 such as a photoreceptor for holding an electrostatic latent image, a developing roller 10 that contacts the image forming body 21 and attaches the toner 20 supported on the surface thereof to make the electrostatic latent image into a visible image, a toner supply roller 22 for supplying the toner 20 to the developing roller 10, and image formation is performed by a series of processes of carrying the toner 20 from a toner container 23 to the image forming body 21 via the toner supply roller 22 and the developing roller 10. The image formation device of the present invention may further be provided with a known component usually used in image formation devices (not illustrated).

In the illustrated image formation device, after the image forming body 21 is charged to a fixed electric potential by a charging roller 25, an electrostatic latent image is formed on the image forming body 21 by an exposure device (not illustrated). Next, as the toner supply roller 22, the developing roller 10, and the image forming body 21 rotate in the direction of the arrow in the drawing, the toner 20 on the toner supply roller 22 is passed via the developing roller 10 to the image forming body 21. The toner 20 on the developing roller 10 is uniformly thinned by the layer forming blade 24. As the developing roller 10 and the image forming body 21 rotate in contact with each other, the toner 20 adheres to an electrostatic latent image of the image forming body 21 from the developing roller 10, and the latent image is visualized. The toner 20 adhering to the latent image is transferred onto a recording medium such as a paper by a transfer roller 26 and the toner 20 remaining on the image forming body 21 after transfer is removed by a cleaning blade 28 of a cleaning unit 27. In the image formation device of the present invention, since the developing roller of the present invention is used as the developing roller 10, it is possible to reduce the toner degradation during durability use while securing the toner carrying performance and suppress the occurrence of toner adhesion to a blade and roller filming.

### EXAMPLES

Hereinafter, the present invention will be described in more detail by way of Examples.

100 parts by mass of a urethane prepolymer synthesized from tolylene diisocyanate (TDI) and polyether polyol and 2 parts by mass of acetylene black were mixed to prepare a urethane prepolymer in which acetylene black was dispersed, which was used as an A component. On the other hand, 30 parts by mass of polyether polyol and 0.1 parts by mass of sodium perchlorate (NaClO₄) were mixed while heating to 70° C., and 4.5 parts by mass of polyether-modified silicone oil (foam stabilizer) and 0.2 parts by mass of dibutyltin dilaurate (a catalyst) were further mixed thereto to prepare a mixture, which was used as a B component. Next, the above-described A component and B component were foamed by a mechanical froth method, and further, injected into a cylindrical mold in which a core metal was set, and a roller main body having an elastic layer made of foamed polyurethane was produced by RIM molding.

To a resin component (Tg: over 0° C.) in which 200 parts by mass of a polyisocyanate (Excel-Hardener HX, manufactured by Asia Industry Co., Ltd.) is added with respect to 100 parts by mass of a polyol (PLACCEL L205AL, manufactured by DAICEL CHEMICAL INDUSTRIES, LTD.), a resin component (Tg: −9° C.) in which 100 parts by mass of a polyisocyanate (Excel-Hardener HX, manufactured by Asia Industry Co., Ltd.) is added with respect to 100 parts by mass of a polyol (PLACCEL 210N, manufactured by DAICEL CHEMICAL INDUSTRIES, LTD.), and a resin component (Tg: −20° C.) in which 50 parts by mass of a polyisocyanate (Excel Hardener HX, manufactured by Asia Industry Co., Ltd.) was added with respect to 100 parts by mass of polyol (PLACCEL 220AL, manufactured by Daicel Chemical Industries Ltd.), two parts by mass of microparticles were further added under the conditions listed on the Tables below to prepare coating compositions. The obtained coating composition was applied on the above-described elastic layer, and cured by heating at 115° C. for 30 minutes, thereby obtaining a surface layer. Developing rollers of the Examples and Comparative Examples were thus obtained.

Each of the obtained test rollers was mounted on a printer LBP5050 manufactured by Canon Inc., and durable printing was performed to confirm the occurrence of development streaks and filming. As results of the confirmation, a case where development streaks and filming did not occur up to 10,000 sheets of printing was evaluated as 10K\textcircled{∘}; a case where development streaks and filming did not occur up to 8,000 sheets of printing but occurred until reaching 10,000 sheets of printing was evaluated as 10K◯, a case where development streaks and filming did not occur up to 6,000 sheets of printing but occurred until reaching 8,000 sheets of printing was evaluated as 8K◯, a case where development streaks and filming did not occur up to 4,000 sheets of printing but occurred until reaching 6,000 sheets of printing was evaluated as 6KΔ; and a case where development streaks and filming occurred up to 4,000 sheets of printing was evaluated as 4Kx . The results are listed on the Tables below in combination.

TABLE 1

| | Microparticles | | | | | | |
|---|---|---|---|---|---|---|---|
| | | | Average | | | | |
| | | | particle | | Tg(° C.) of | Evaluation result | |
| | | Universal | diameter | | resin | Development | |
| | Material | hardness *⁷ | (μm) | Tg | component | streaks | Filming |
| Comparative | Melamine resin *¹ | 2.1 | 14 | 0° C. or | −9 | 4KX | 4KX |
| Example 1 | | | | higher | | | |
| Comparative | Melamine resin *¹ | 2.1 | 14 | 0° C. or | −20 | 6KΔ | 6KΔ |
| Example 2 | | | | higher | | | |
| Comparative | Acryl resin *² | 2.2 | 14 | 0° C. or | −9 | 4KX | 4KX |
| Example 3 | | | | higher | | | |
| Comparative | Acryl resin *² | 2.2 | 14 | 0° C. or | −20 | 6KΔ | 6KΔ |
| Example 4 | | | | higher | | | |
| Comparative | Urethane resin E*⁸ | 2.1 | 14 | 35° C. | −20 | 6KΔ | 6KΔ |
| Example 5 | | | | | | | |
| Example 1 | Urethane resin A*³ | 2.1 | 14 | −13° C. | −9 | 8K◯ | 6KΔ |
| Example 2 | Urethane resin A*³ | 2.1 | 14 | −13° C. | −20 | 10K◯ | 10K◯ |
| Example 3 | Urethane resin B*⁴ | 2.3 | 8 | −13° C. | −20 | 8K◯ | 6KΔ |
| Example 4 | Urethane resin C*⁵ | 1.8 | 14 | −34° C. | −20 | 10K⊚ | 10K◯ |
| Example 5 | Urethane resin D*⁶ | 1.6 | 14 | −52° C. | −9 | 10K◯ | 8K◯ |
| Example 6 | Urethane resin D*⁶ | 1.6 | 14 | −52° C. | −20 | 10K⊚ | 10K⊚ |
| Example 7 | Urethane resin A*³ | 2.1 | 14 | −13° C. | Over 0 | 8K◯ | 6KΔ |
| Example 8 | Urethaneresin F*⁹ | 2.1 | 14 | −13° C. | −20 | 8K◯ | 8K◯ |

*¹ OPTBEADS 10500M (manufactured by Nissan Chemical Industries, Ltd.)
*² ART PEARL GR400 (manufactured by Negami Chemical Industrial Co., Ltd.)
*³ART PEARL C400 (manufactured by Negami Chemical Industrial Co., Ltd.)
*⁴ART PEARL C800 (manufactured by Negami Chemical Industrial Co., Ltd.)
*⁵ART PEARL P400 (manufactured by Negami Chemical Industrial Co., Ltd.)
*⁶ART PEARL JB400 (manufactured by Negami Chemical Industrial Co., Ltd.)
*⁷ Using a Fischer hardness tester H100C, the hardness at the time when a Vickers indenter was used and pushed in at 20 mN/20 s with an indentation depth of 1 μm was measured.
*⁸ART PEARL U400 (manufactured by Negami Chemical Industrial Co., Ltd.)
*⁹ART PEARL C600 (manufactured by Negami Chemical Industrial Co., Ltd.)

As listed on the above Table, in the developing roller of each of the Examples in which the surface layer was formed using a coating composition containing a resin component containing a polyol and an isocyanate and micro particles having a Tg of −13° C. or less, it was confirmed that the occurrence of development streaks and roller filming was suppressed.

In the formulation of Example 6, the developing roller of each of the Examples was produced by changing the blending parts of the microparticles with respect to 100 parts by mass of a polyol component as listed on the Table below, and the occurrence of development streaks and filming was confirmed in a similar manner to the above. Further, the toner carrying performance was also evaluated according to the following. These results are also listed on the Table below in combination.

Each test roller was incorporated in a commercially available printer as a developing roller and then idly rotated in the printer to form a uniform thin layer of toner on the surface of the developing roller. The thin layer of the toner was sucked to be introduced into a Faraday cage, the weight of the sucked toner was measured, and the area of a portion on which the toner was removed by suction on the surface of the developing roller was measured to calculate the toner weight per unit area, thereby determining the toner carrying amount. As a result, a case where the ratio of the toner carrying amount with respect to the reference developing roller of the printer was within ±10% was evaluated as ◯, a case where the ratio was ±more than 10% and 15% or less was evaluated as Δ, and a case where the ratio exceeds ±15% was evaluated as x.

TABLE 2

| | Exam- | Exam- | Exam- | Exam- | Exam- | Exam- |
|---|---|---|---|---|---|---|
| | ple | ple | ple | ple | ple | ple |
| | 6 | 9 | 10 | 11 | 12 | 13 |
| Number of | 2 | 1 | 1.5 | 4.5 | 6 | 8 |
| parts (parts | | | | | | |
| by mass) | | | | | | |
| Toner carrying | ◯ | Δ | ◯ | ◯ | ◯ | Δ |
| performance | | | | | | |
| Development | 10K⊚ | 10K◯ | 10K◯ | 10K⊚ | 10K⊚ | 10K⊚ |
| streaks | | | | | | |
| Filming | 10K⊚ | 10K⊚ | 10K⊚ | 10K⊚ | 10K◯ | 10K◯ |

As listed on the above Table, it was confirmed that, when the blending parts of the microparticles was too large or too small, the toner carrying performance was degraded, and by setting the blending parts of the microparticles within an appropriate range, toner degradation can be reduced while ensuring the toner carrying performance.

### DESCRIPTION OF SYMBOLS

### 1 Shaft

2 Elastic layer
3 Surface layer
10 Developing roller

### 20 Toner

21 Image forming body
22 Toner supply roller
23 Toner container
24 Layer forming blade
25 Electrifying roller
26 Transfer roller
27 Cleaning unit
28 Cleaning blade

1. A conductive roller coating composition containing a resin component including a polyol and an isocyanate, and microparticles,
wherein a Tg of the microparticles is −13° C. or less.

2. The conductive roller coating composition according to claim 1, wherein
a Tg of the resin component is 0° C. or less.

3. The conductive roller coating composition according to claim 1, wherein
the microparticles are made of a polyurethane resin.

4. The conductive roller coating composition according to claim 1, wherein
an average particle diameter of the microparticles is 10 μm or more.

5. The conductive roller coating composition according to claim 1, wherein
from 1.5 to 6.0 parts by mass of the microparticles are contained with respect to 100 parts by mass of the polyol component.

6. The conductive roller coating composition according to claim 1, wherein
a universal hardness of the microparticles at an indentation depth of 1 μm is 2.0 or less.

7. A developing roller comprising: a shaft; and an elastic layer supported on an outer periphery of the shaft,
wherein an outer periphery of the elastic layer is coated with the conductive roller coating composition according to claim 1.

8. An image formation device,
wherein the developing roller according to claim 7 is mounted.
